(19) United States
(12) Patent Application Publication
(10) Pub. No.: US 2018/0187630 A1
(43) Pub. Date: Jul. 5, 2018

(54) SUPPLY DEVICE FOR AN ELECTRIC ACTUATOR SYSTEM

(71) Applicant: Safran Nacelles, Gonfreville L'Orcher (FR)

(72) Inventors: Patrick GONIDEC, Gonfreville L'Orcher (FR); Hakim MAALIOUNE, Orgeval (FR)

(73) Assignee: Safran Nacelles, Gonfreville L'Orcher (FR)

(21) Appl. No.: 15/904,671

(22) Filed: Feb. 26, 2018

Related U.S. Application Data
(63) Continuation of application No. PCT/FR2016/052114, filed on Aug. 24, 2016.

(30) Foreign Application Priority Data
Aug. 24, 2015 (FR) 15/57886

(51) Int. Cl. F02K 1/76; B64D 29/06; B64D 33/04; F02K 1/70

(52) U.S. Cl. CPC F02K 1/763; B64D 29/06; B64D 27/16; F02K 1/70; B64D 33/04

(57) ABSTRACT

The present disclosure relates to a nacelle for an aircraft turbofan engine and an aircraft that includes a nacelle that includes a supply device for supplying electric power to an electric actuator system allowing movement of a mobile member for deflecting a stream between a first position parallel or substantially parallel to the flow of the stream and a second position allowing the flow of the stream to be deflected so as to modify the path of the stream in one direction and/or the speed of the stream.

### CROSS-REFERENCE TO RELATED APPLICATIONS

This application is a continuation of International Application No. PCT/FR2016/052114, filed on Aug. 24, 2016, which claims priority to and the benefit of FR 15/57886 filed on Aug. 24, 2015. The disclosures of the above applications are incorporated herein by reference.

### FIELD

The present disclosure relates to a nacelle for a bypass turbojet engine as well as an aircraft including such a nacelle.

### BACKGROUND

The statements in this section merely provide background information related to the present disclosure and may not constitute prior art.

An aircraft is driven by several turbojet engines each housed in a nacelle also accommodating a set of ancillary actuating devices linked to the operation thereof and ensuring various functions when the turbojet engine is in operation or stopped. These ancillary actuating devices comprise in particular a thrust reverser actuating mechanical system.

A nacelle generally has a tubular structure along a longitudinal axis comprising an air inlet upstream of the turbojet engine, a middle section intended to surround a fan of the turbojet engine, a downstream section accommodating a thrust reversal means and intended to surround the combustion chamber of the turbojet engine. The tubular structure is generally terminated by an ejection nozzle whose outlet is located downstream of the turbojet engine.

Modern nacelles are intended to accommodate a turbojet engine capable of generating via the blades of the rotating fan a hot air flow (also called “main flow”) coming from the combustion chamber of the turbojet engine, and a cold air flow (“secondary flow”) which flows outside the turbojet engine through an annular passage, also called “secondary flow path”.

The term “downstream” means the direction corresponding to the direction of the cold flow air penetrating the turbojet engine. The term “upstream” refers to the opposite direction.

Said secondary flow path is formed by an outer structure, called Outer Fixed Structure (OFS) and a concentric inner structure, called Inner Fixed Structure (IFS), surrounding the structure of the motor itself downstream of the fan. The inner and outer structures belong to the downstream section. The outer structure (OFS) may include one or more cowl(s) sliding along the longitudinal axis of the nacelle between a position allowing the evacuation of the reverse airflow and a position preventing such an evacuation.

Moreover, in addition to the thrust reversal function, the sliding cowl belongs to the rear section and has a downstream side forming the ejection nozzle aiming to channel the ejection of the cold airflow, hereinafter called “main air flow” or “secondary air flow”. This nozzle provides the power necessary for the propulsion by imparting a velocity to the ejection flow. This nozzle is associated to an actuating system independent or not of said actuating system of the cowl allowing varying and optimizing its section depending on the flight phase in which the aircraft is located.

It may be advantageous to reduce the inlet or ejection section of the main airflow in the space formed by the air inlet and the annular flow path.

For example, it is possible to reduce the ejection section of the main airflow at the outlet of the annular flow path via a variable nozzle (“Variable Fan Nozzle” VFN) formed by movable panels carried directly by the thrust reverser movable cowl.

Such a variable nozzle allows modulating the thrust by varying the outlet section thereof in response to variations in the adjustment of the power of the turbojet engine and of the flight conditions.

As previously described, the outer structure may include one or more sliding cowl(s) along the longitudinal axis of the nacelle between a first position and a second position allowing the evacuation of the reverse airflow. When sliding the cowls, an energy source is connected to an actuating system allowing actuating the variable nozzle either by a friction system, of a catenary type whose electrostatic discharges may cause strong electromagnetic fields which may disturb the proper operation of some electrical components, or of the cable chain type, which show a significant deficit of reliability.

### SUMMARY

The present disclosure provides a device to supply power to movable parts relative to each other, in particular to supply power to an electrical energy consuming member, for example an electric motor carried by a thrust reverser movable cowl with an electrical energy source located on a fixed nacelle portion (OFS) while allowing the expansion of the cowls without breaking the supply circuit and without contact between the conductors as is the case with catenaries.

The present disclosure provides a nacelle for an aircraft turbojet engine, the nacelle comprising a power supply device having an energy source carried by a fixed structure of the nacelle and providing the energy thereof to an electrical energy consuming member carried by a movable cowl of a thrust reverser. The electrical energy consuming member comprises a set of bivalent nodes configured to allow the electrical energy consuming member to totally or partially transform the alternating electrical energy into a mechanical energy. The power supply device further comprises at least one set of energy transfer devices configured to connect an electrical energy source to the electrical energy consuming member and being intended to totally or partially transfer the electrical energy to the electrical energy consuming member. The set of energy transfer devices comprises a first electrical conductor configured to be electrically connected to the energy source and a second electrical conductor configured to be electrically connected to the electrical energy consuming member. The first electrical conductor comprises a first cylindrical tube secured to the movable cowl and the second conductor comprises a second cylindrical tube secured to the fixed structure of the thrust reverser and the first electrical conductor and the second electrical conductor are configured to form at least one electrical component among a capacitive electrical component and an inductive electrical component and to be electrically insulated from each other when the movable cowl is stopped or displaced relative to the fixed structure.

Thanks to the arrangements according to the present disclosure, the power supply device makes it possible to supply electrical power to the electrical actuating system and the first electrical conductor and the second conductor have a well-defined position.

The power supply device may further have one or more of the following features, taken alone or in combination.

According to one form, the electrical component is configured to be electrically insulated in direct current relative to each other when the movable cowl is stopped or displaced relative to the fixed structure.

Thus, thanks to this arrangement, the power supply device can supply electrical power to the electrical actuating system.

According to another form, the electrical energy-consuming member belongs to a variable nozzle actuating system of the movable cowl of the thrust reverser. The electrical energy-consuming member may form a motor of the actuating system.

Thus, thanks to this arrangement, the variable nozzle of the movable cowl of the thrust reverser may be actuated.

According to another form, the first cylindrical tube and the second cylindrical tube are configured to cooperate and in one form, the first cylindrical tube and the second cylindrical tube are configured to slide relative to each other and are located opposite to each other at least when the sliding cowl of the nacelle is closed to thereby to constitute an insulating capacitor or an insulating transformer.

Thus, thanks to this arrangement, the first cylindrical tube and the second cylindrical tube form a capacitor.

According to yet another form, the first conductor is electrically connected to the first cylindrical tube, and in one aspect, the first electrical conductor electrically contacts one of the ends of the first cylindrical tube. Thus, thanks to this arrangement, a charge accumulation may be carried out on the surface of the first cylindrical tube.

According to another form, the second conductor is electrically connected to the second cylindrical tube, and in one form, the second electrical conductor electrically contacts one of the ends of the second cylindrical tube.

Thus, thanks to this arrangement, a charge accumulation may be carried out on the surface of the first cylindrical tube.

According to one form, the power supply device comprises a first capacitive energy transfer device and a second capacitive energy transfer device, the first capacitive energy transfer device being electrically connected to the electrical energy source via the first electrical conductor and to the electrical energy consuming member via the second electrical conductor, and the second capacitive energy transfer device being electrically connected to the electrical energy consuming member via the first electrical conductor and to the electrical energy source via the second electrical conductor.

Thus, thanks to this arrangement, the electrical energy-consuming member may be supplied with electrical energy in one of the positions of the nacelle.

According to another form, the power supply device comprises a first inductive energy transfer device and a second inductive energy transfer device. The first inductive energy transfer device is electrically connected to the electrical energy source via the first electrical conductor and to the electrical energy consuming member via the second electrical conductor. The second inductive energy transfer device is electrically connected to the electrical energy consuming member via the first electrical conductor and to the electrical energy source via the second electrical conductor.

Thus, thanks to this arrangement, the electrical energy-consuming member may be supplied with electrical energy in one of the positions of the nacelle.

According to one form, the first cylindrical tube comprises at least one main inner surface and at least one main outer surface and the second cylindrical tube comprises at least one secondary inner surface and at least one secondary outer surface, in which one of the cylindrical tubes among the first cylindrical tube and the second cylindrical tube comprises an electrical insulation layer on at least one surface among the main inner surface, the main outer surface, the secondary inner surface and the secondary outer surface.

Thus, thanks to this arrangement, the energy transfer desired for the electrical energy-consuming member may be carried out without electrical contact.

According to another form, the capacitance of the connection circuit is compensated by an additional electrical induction.

Thus, thanks to this arrangement, the capacitance of the circuit is compensated.

According to another form, the induction of the connection circuit is compensated by an additional electrical capacitance.

Thus, thanks to this arrangement, the inductance of the circuit is compensated.

According to another form, a capacitive component is inserted into the circuit to reduce the reactance of the circuit.

Thus, thanks to this arrangement, the reactance of the circuit is reduced.

According to another form, the first cylindrical tube extends at least partly in the second cylindrical tube.

Thus, thanks to this arrangement, the first cylindrical tube may slide with the second cylindrical tube.

According to another form, the second cylindrical tube extends at least partly in the first cylindrical tube.

Thus, thanks to this arrangement, the second cylindrical tube may slide with the first cylindrical tube.

According to another form, the main nested cylindrical tubes and the secondary nested cylindrical tubes are configured to slide relative to each other and in one form, one is inside the other.

Thus, thanks to this arrangement, the surface of the cylindrical tubes is increased.

According to another form, the capacitive energy transfer device is a capacitor.

Thus, thanks to this arrangement, the energy transfer is transmitted without contact.

According to another form, the electrical energy source and the first electrical conductor of the first capacitive energy transfer device are secured to the fixed structure and the motor just like the second electrical conductor of the first capacitive energy transfer device are secured to the movable cowl.

Thus, thanks to this arrangement, the circuit may be separated and reassembled.

According to another form, the first cylindrical tube is configured to have totally or partially one of its surfaces among the first inner surface and the first outer surface opposite to one of the surfaces of the second cylindrical tube among the second inner surface and the second outer surface.

Thus, thanks to this arrangement, the first cylindrical tube and the second cylindrical tube form a capacitor.

According to another form, the electrical energy source and the second electrical conductor of the second capacitive energy transfer device are secured to the fixed structure and the motor just like the first electrical conductor of the second capacitive energy transfer device are secured to the movable cowl.

Thus, thanks to this arrangement, the circuit may be separated and reassembled.

According to another form, the power supply device comprises an inductance, configured to rebalance the reactance of the circuit, either on the fixed structure or on the movable cowl.

Thus, thanks to this arrangement, the reactance of the circuit is either on the fixed structure or on the movable cowl.

According to another form, the first electrical conductor comprises a first solenoid secured to the movable cowl and the second conductor comprises a second solenoid secured to the fixed structure of the thrust reverser.

Thus, thanks to this arrangement, the first solenoid and the second solenoid have a fixed position.

According to another form, the first conductor is electrically connected to the first solenoid and the first electrical conductor may electrically contact the two ends of the first solenoid.

Thus, thanks to this arrangement, the current may flow in the solenoid.

According to another form, the second conductor is electrically connected to the second solenoid and the second electrical conductor may electrically contact the two ends of the second solenoid.

Thus, thanks to this arrangement, the current may flow in the solenoid.

According to another form, the first solenoid extends at least partly in the second solenoid.

Thus, thanks to this arrangement, the magnetic field is transferred totally or partly from one solenoid to the other.

According to another form, the second solenoid extends at least partly in the first solenoid.

Thus, thanks to this arrangement, the magnetic field is transferred totally or partly from one solenoid to the other.

According to another form, the first solenoid comprises at least one main inner surface and at least one main outer surface.

Thus, thanks to this arrangement, the magnetic field is transferred totally or partly from one solenoid to the other.

According to another form, the second solenoid comprises at least one main inner surface and at least one secondary outer surface.

Thus, thanks to this arrangement, the magnetic field is transferred totally or partly from one solenoid to the other.

According to another form, one of the solenoids among the first solenoid and the second solenoid comprises an electrical insulation layer on at least one surface among the main inner surface, the main outer surface, the secondary inner surface, and the secondary outer surface.

Thus, thanks to this arrangement, the magnetic field is transferred totally or partly from one solenoid to the other without electrical contact between the two solenoids.

According to another form, the first solenoid and the second solenoid are configured to slide relative to each other.

Thus, thanks to this arrangement, the solenoids may be displaced relative to each other during the displacement of a portion of the nacelle.

According to another form, the inductive energy transfer device is a solenoid.

Thus, thanks to this arrangement, the energy transfer may be carried out by induction.

According to another form, the first electrical conductor and the second electrical conductor are configured to form an inductive energy transfer device.

Thus, thanks to this arrangement, the energy transfer is carried out by induction.

According to another form, the electrical energy source and the first electrical conductor of the first inductive energy transfer device are secured to the fixed structure and the motor just like the second electrical conductor of the first inductive energy transfer device are secured to the movable cowl.

Thus, thanks to this arrangement, the electrical energy-consuming member may be supplied with electrical energy in one of the positions of the nacelle.

According to another form, the electrical energy source and the second electrical conductor of the second inductive energy transfer device are secured to the fixed structure and the motor just like the first electrical conductor of the second inductive energy transfer device are secured to the movable cowl.

Thus, thanks to this arrangement, the positions of the second inductive energy transfer device and the first inductive energy transfer device are fixed relative to each other.

According to another form, the power supply device comprises a capacitance, configured to rebalance the reactance of the circuit, either on the fixed structure or on the movable cowl.

Thus, thanks to this arrangement, the reactance of the circuit is rebalanced.

Other features and advantages of the present disclosure will appear better upon reading the following description of various forms of the present disclosure given as a non-limiting example.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows an example of a nacelle in which a power supply device according to the present disclosure is implemented;

FIG. 2 shows an example of energy transfer devices when a nacelle is in an open position according to the present disclosure;

FIG. 3 illustrates an example of a set of energy transfer devices in a closing position according to the present disclosure;

FIG. 4 exposes an example of energy transfer devices in an open position according to the present disclosure;

FIG. 5 shows an example of a set of energy transfer devices according to the present disclosure in the form of a capacitive electrical component in a closing position;

FIG. 6 shows an example of a set of energy transfer devices according to the present disclosure in the form of a capacitive electrical component in an open position;

FIG. 7 illustrates an example of a capacitive electrical component in the form of a comb according to the present disclosure;

FIG. 8 exposes an example of a tubular capacitive electrical component with a rectangular base according to the present disclosure;

FIG. 9 shows an example of a tubular capacitive electrical component according to the present disclosure;

FIG. 10 shows an example of a set of energy transfer devices according to the present disclosure in the form of an inductive electrical component in a closing position;

FIG. 11 illustrates an example of a set of energy transfer devices according to the present disclosure in the form of an inductive electrical component in an open position;

FIG. 12 illustrates an exemplary circuit using a set of capacitive electrical component according to the present disclosure; and

FIG. 13 illustrates an example of a circuit using a set of inductive electrical component according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or elements fulfilling identical functions might keep the same references so as to simplify the understanding of the present disclosure.

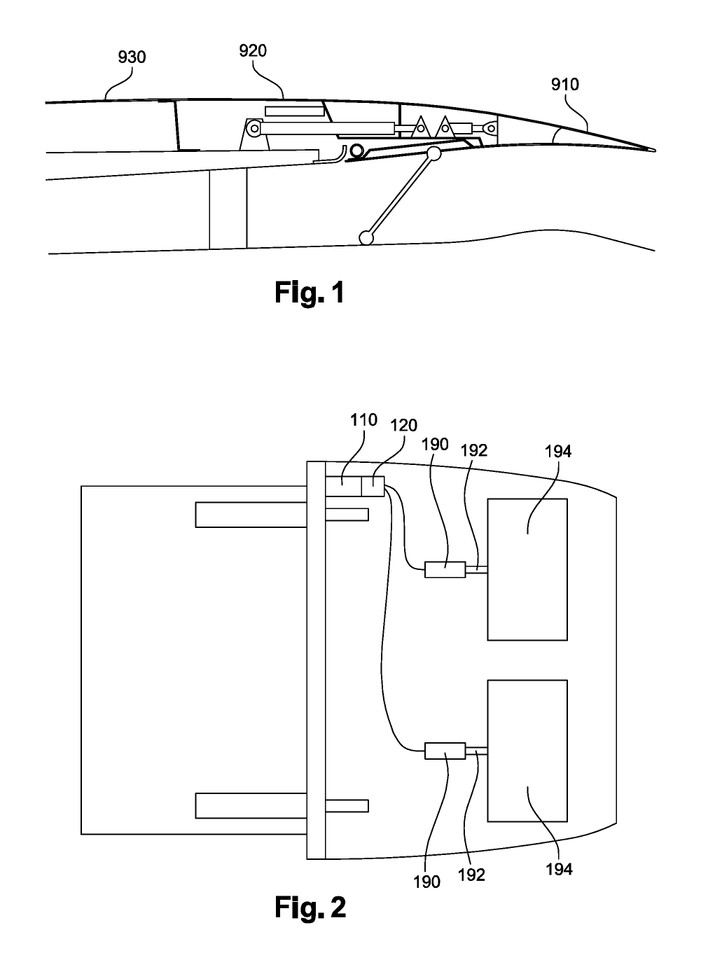

With reference to FIGS. 1 and 2, a nacelle 900 is intended to constitute a tubular structure for a bypass turbojet engine and serves to channel the airflows that it generates via blades of a fan, namely a hot air flow passing through a combustion chamber and a cold airflow circulating outside the turbojet engine.

The nacelle 900 generally has a structure comprising an upstream section 930 forming an air inlet, a middle section 920 surrounding the fan of the turbojet engine and a downstream section 910 surrounding the turbojet engine.

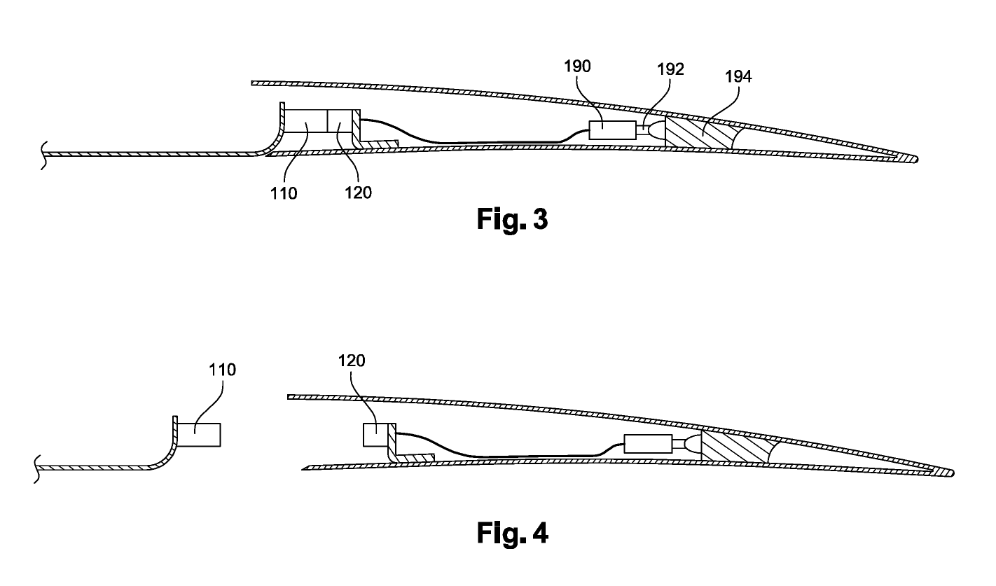

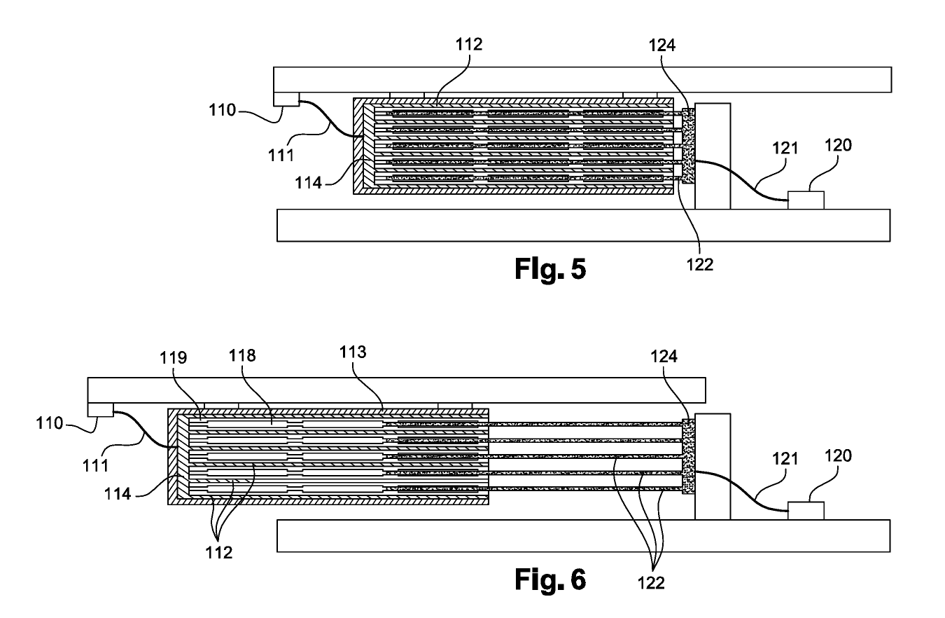

On the upstream section 930 or on the middle section 920 there is an electrical energy source 180 intended to supply an electrical energy-consuming member 190 via a set of energy transfer devices 170 sliding relative to each other, more precisely by a first electrical conductor 110 of a set of energy transfer devices 170. The middle section 920, fixed portion of the nacelle 900, is further constituted by a fan cowl and a front frame comprising a fixed deflection edge providing the aerodynamic line with the downstream portion of a fan casing surrounding the fan of the turbojet engine, when the middle section 920 and the downstream portion are in the first position, that is to say in the closing position as shown in FIG. 3.

The downstream section 910 comprises an outer structure including a thrust reverser device, a motor fairing inner structure defining with the outer structure a flow path intended for the circulation of a cold flow in the case of the bypass turbojet engine nacelle 900, a portion of the set of energy transfer devices 170, more particularly a second electrical conductor 120 and an electrical energy consuming member 190 electrically connected to the second electrical conductor 120. The electrical energy-consuming member 190 is configured to transform totally or partially the electrical energy into mechanical energy. This mechanical energy allows, indeed, the displacement of a flow deflection movable member 194, ejection nozzles for example, between a first position parallel or substantially parallel to the stream of the flow and a second position allowing the deflection of the stream of the flow by varying the section delimited by the ejection nozzles and accordingly influencing the flows. This variation of the section delimited by the ejection nozzles occurs in most cases, when the downstream section 910 covers the cascade vanes, that is to say when the downstream section 910 is positioned in the first position, in other words when the downstream section 910 in the closing position and it, that is to say the variation of the section delimited by the ejection nozzles, allows the deflection of the stream of the flow so as to modify the path of the flow in one direction and/or the velocity of the flow.

In this first position, also called closing position, the set of energy transfer devices 170 forms a closed circuit, that is to say a circuit in which the energy transfer may be performed between the electrical energy source 180 and the electrical energy-consuming member 190.

In order that this energy transfer may be performed, the first electrical conductor 110 comprises a set of main surfaces 112 and the second electrical conductor 120 comprises a set of secondary surfaces. According to a first form, the set of main surfaces 112 and the set of secondary surfaces 122 comprise a conductive material and are connected respectively to the first electrical conductor 110 and to the second electrical conductor 120 by a junction member, more precisely a main junction member 114 and respectively a secondary junction member 124 allowing the passage of the current between the first electrical conductor 110 and the set of main surfaces 112 and the same applies between the set of secondary surfaces 122 and the second electrical conductor 120. Thus, thanks to this configuration, an electrical contact is established between the surfaces, that is to say between the set of main surfaces 112 and the set of secondary surfaces 122 or more precisely the first electrical conductor 110 and the second electrical conductor 120 such that the electrical energy source 180 may supply the electrical energy consuming member 190.

The downstream section 910 comprises thrust reversal and a motor fairing inner structure defining with the thrust reversal a flow path intended for the circulation of a cold airflow of the turbojet engine.

The downstream section 910 further comprises a front frame, a movable cowl, and an ejection nozzle section as previously described. The front frame is extended by the movable cowl sliding along the longitudinal axis of the nacelle 900. The front frame also supports a plurality of cascade vanes housed in the thickness of the movable cowl, when said movable cowl is in the first position, that is to say in the closing position.

When the downstream section 910 uncovers the plurality of cascade vanes in order to allow the thrust reversal device to obstruct the passage of the cold air flow, the downstream section 910 is detached from the middle section 920 so as to open the housing of the cowl, thus, a second position or more precisely an opening position, as described in greater detail below. During this flow deflection operation, the set of main surfaces 112 and the set of secondary surfaces 122 are displaced relative to each other.

This form has the advantage of reducing the risk of any misalignment when the operation of flow deflection will be completed and the cascade vanes will be covered.

According to another form, an insulation layer 160, for example a plastic material and/or a non-conductive polymer may be applied on one of the surfaces or on the set of main 111 and secondary 121 surfaces so as to avoid an electrostatic discharge between the surfaces.

Of course, in order that the energy transfer may take place between the set of main surfaces 111 and the set of secondary surfaces 121, or more precisely between the electrical energy source 180 and the electrical energy-consuming member 190, it is appropriate to provide an electrical energy source 180 providing an alternating voltage and/or an alternating current.

In order that this electrical energy may be consumed, the electrical energy consuming member 190 comprises a set of bivalent nodes (not shown) which, along the direction of the current and/or the voltage, may be input and/or output nodes.

Indeed, since the set of main surfaces 112 and/or secondary surface are covered with an insulation layer 160, the set of main surfaces 112 and the set of secondary surfaces 121 form a capacitive electrical component.

According to another form, the first electrical conductor 110 may comprise a first wall 113 forming a main tubular element 115 delimiting a main housing 117 and the second electrical conductor 120 may comprise a second wall 123 forming a secondary tubular element 125 delimiting a secondary housing 127.

Thus, in this form, the main tubular element 115 delimited by the inner main surface 119, may house the secondary tubular element 125 in the main tubular housing 117 provided for this purpose. Consequently, the outer secondary surface 128, delimiting the secondary tubular housing 127, is opposite to the inner main surface 119 so as to form a capacitive electronic component. According to a similar form, the secondary tubular housing 127 might house the main tubular element 113.

According to the two variants described above, the main tubular element 113 comprises an inner main surface 119 and an outer main surface 118 electrically connected to the first electrical conductor 110 by a main junction member 114 and the secondary tubular element 125 comprises an inner secondary surface 129 and an outer secondary surface 128 electrically connected to the second electrical conductor 120 by a secondary junction member 124. Thus, thanks to this configuration, the first wall, according to a variant, may be made of a composite material, in order to lighten the main tubular element 113 and the inner main surface 119 as well as the outer main surface 118 made of conductive material so as to form a portion of the capacitive electronic component knowing that the other portion is formed by the secondary tubular element 125. It is quite obvious that the secondary tubular element 125 comprises the same features as the main tubular element 113, namely a second wall 123 made of composite material as well as an inner secondary surface 129 and an outer secondary surface 128 made of conductive material. The set of inner and outer surfaces of the main and secondary walls are covered with an insulation layer 160. In one form, the insulation layer 160 is made of Teflon®.

Consequently, when the middle section 920 and the downstream section 910 are displaced relative to each other in a substantially parallel manner, that is to say at an angle comprised between 0° and 10°, the inner and outer surfaces of the tubular elements are displaced substantially parallel to each other. In other words, taking as reference one of the inner main surfaces 119, one of the outer secondary surfaces 128 is displaced in a plane parallel to the plane described by the set of inner main surfaces 119.

According to another form, the first electrical conductor 110 may comprise a main set of concentric or coaxial tubular elements just like the second electrical conductor 120 may also comprise a secondary set of concentric or coaxial tubular elements. The term “concentric” means a set of tubular elements whose geometric and/or gravity centers would be the same, and the term “coaxial” means a set of tubular elements whose gravity and/or geometric centers would be placed on the same axis.

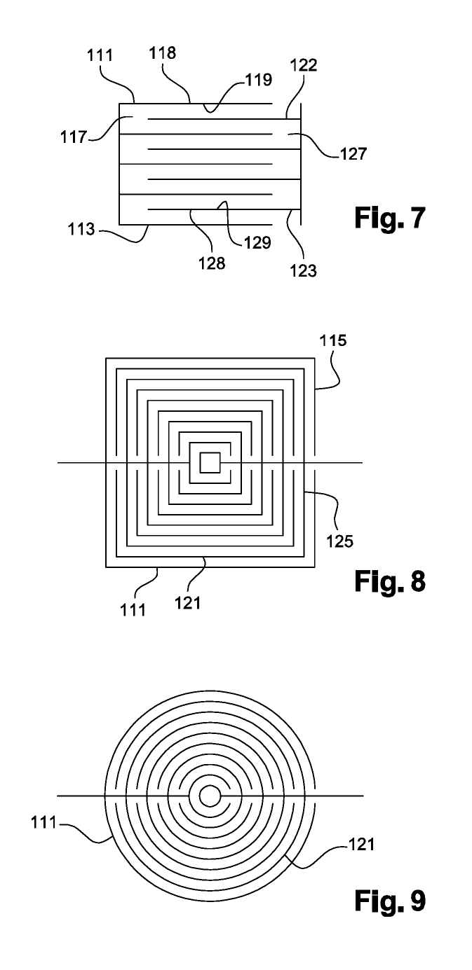

The set of main concentric tubular elements form by the set of main concentric walls 117 intended to house the set of secondary concentric walls 127 such that it may be observed, according to a sectional view, an alternation of main concentric walls and secondary concentric walls, as it can be observed in FIGS. 7 to 9. More precisely, it is possible to discern an alternation of main concentric walls and secondary concentric walls 123 electrically insulated by an insulation layer 160. In one form, the insulation layer 160 is made of polytetrafluoroethylene covering either the main surface 111 or the secondary surface 121 or both.

The advantage of polytetrafluoroethylene is to have a very good strength with relatively high temperature and to withstand most chemicals. An important feature of polytetrafluoroethylene is its low friction coefficient, which allows both to facilitate the imbrications of the set of concentric or coaxial main walls in the set of concentric or coaxial secondary housings so as to implicitly facilitate setting the set of inner and/or outer main surfaces 112 facing the set of inner and/or outer secondary surfaces 122.

Furthermore, it is possible that dust may interfere with the imbrications and/or the displacement of the walls in their housing. To this end, it is provided a set of cavities in the insulation layer 160 such that when the walls are displaced, the dust is conveyed to the cavities 162 where they are detained. It is possible, for maintenance reasons, that the cavities are connected by a channel so as to allow the dust to emerge more easily from the cavities 162 of the concentric housings when desired.

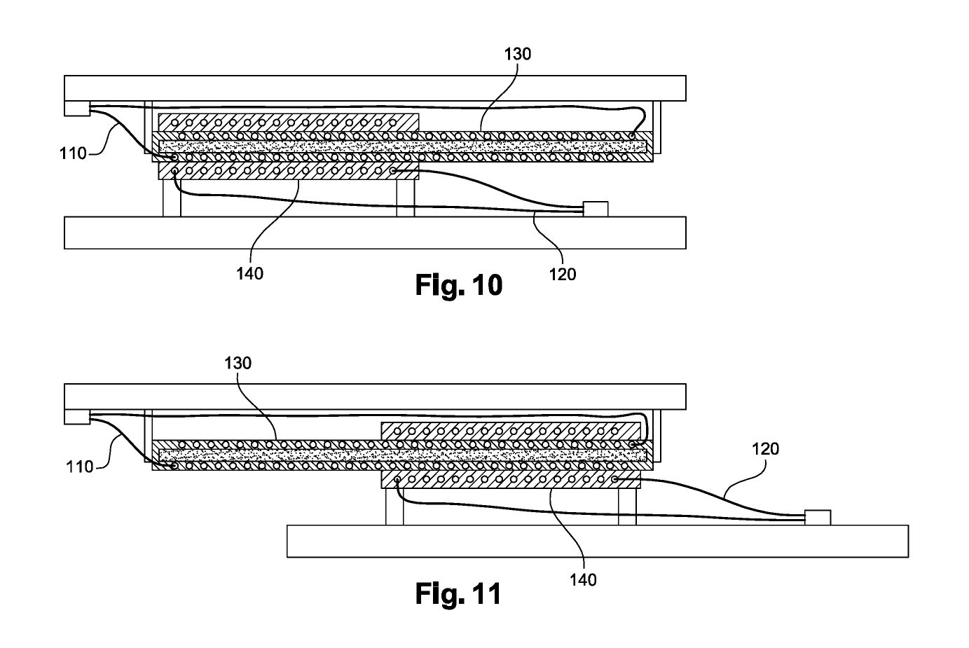

Referring to FIGS. 10 to 11, an alternative to the capacitive electrical component might be an inductive electrical component. In this form, the first electrical conductor 110 is configured to form a main winding 130 with turns wound in a helix shape and the second electrical conductor 120 is configured to form a secondary winding 140 with turns also wound in a helix shape. Of course, the main 130 and/or the secondary 140 winding(s) may form a winding whose turns would be contiguous, a solenoid or a coil, as needed.

The main 130 and/or secondary 140 winding(s), as previously described, could be a winding whose turns would be contiguous, a solenoid or a coil, may delimit a main housing 117 and respectively a secondary housing 127. Thus, it is allowed to the secondary winding 140 to be housed in the main housing 117 delimited by the main winding 130. According to another form, the main 130 and/or secondary 140 winding(s) may be wound on a main 113 and respectively secondary 123 tubular elements. This form has the advantage of clearly delimiting a main housing 117 and respectively a secondary housing 127, but also, according to the configuration of the winding, a uniform magnetic field. Meaning a regular housing in the space.

It is possible that the main 117 and/or secondary 127 housing(s) formed by the main 130 and/or secondary 140 winding(s) is/are configured to house a soft-iron element in order to allow a good conduction of the magnetic flux within the main 117 and/or secondary 127 housing(s).

Similar to the various forms previously described, an insulation layer 160 may cover the main winding 130 and/or the secondary winding 140 such that no electrostatic discharge may occur during the energy transfer by induction between the first winding and the second winding.

According to the configuration and the number of turns of the inductive electrical component, a compensation device may be inserted into the power supply device. More precisely, a capacitive compensation device 152 may be inserted into the power supply device in order to reduce the reactance of the circuit, that is to say the set formed by the set of electrical energy transfer and the electrical energy-consuming member 190.

Similarly, an inductive compensation device 151 may be inserted into the power supply device in order to reduce the reactance of the circuit. Moreover, in order to reduce the circuit reactance, a voltage regulator 155, that is to say a power converter, a chopper in parallel and/or in series or a combination of the three may be connected in series with the energy transfer device so as to form a closed circuit and is configured to regulate the electrical energy during the transfer between the energy source and the electrical energy consuming member 190 via the energy transfer device. This form has the advantage of being capable of improving the energy transfer. Indeed, the frequency regulated by the voltage regulator allows reducing the reactance of the circuit, in other words, when the circuit is in resonance.

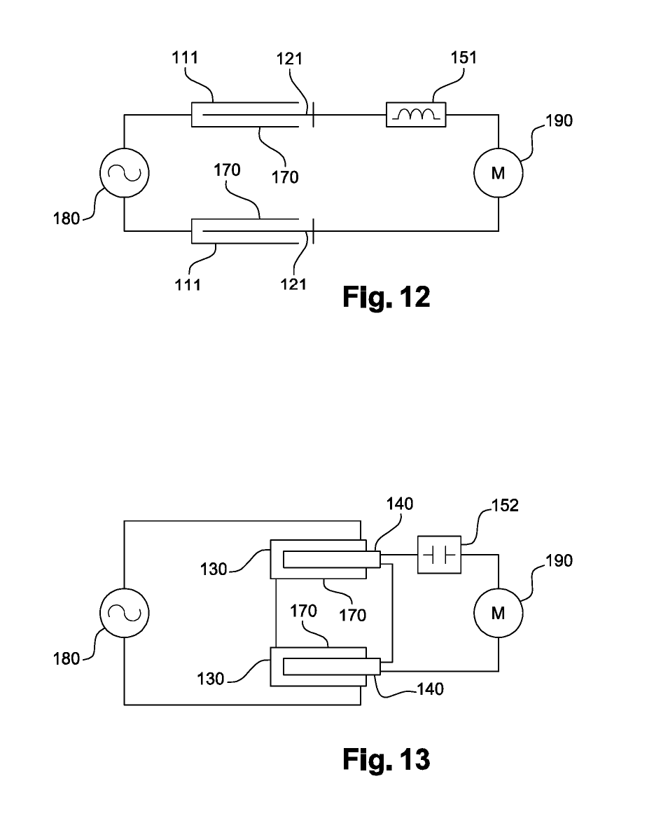

As illustrated in FIG. 12, the circuit may comprise an energy source, a capacitive electrical component, an inductive compensation device 151 in order to compensate the reactance of the circuit and an energy-consuming member.

In FIG. 13, it is possible to observe another form in which the circuit comprises an energy source 180, an inductive electrical component, and a capacitive compensation device 152 in order to compensate the reactance of the circuit and an energy-consuming member.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A nacelle for an aircraft turbojet engine comprising:
a power supply device having an energy source carried by a fixed structure of the nacelle; and
an electrical energy consuming member carried by a movable cowl of a thrust reverser, the electrical energy consuming member comprising a set of bivalent nodes configured to totally or partially transform alternating electrical energy into mechanical energy,
wherein the power supply device further comprises at least one set of energy transfer devices configured to connect an electrical energy source to the electrical energy consuming member and totally or partially transfer the electrical energy to the electrical energy consuming member,
wherein the at least one set of energy transfer devices comprises a first electrical conductor electrically connected to the energy source and a second electrical conductor electrically connected to the electrical energy consuming member, wherein the first electrical conductor comprises a first tubular element secured to the movable cowl and the second electrical conductor comprises a second tubular element secured to a fixed structure of the thrust reverser,
wherein and the first and second electrical conductors are configured to form at least one electrical component selected from the group consisting of a capacitive electrical component and an inductive electrical component, wherein the first and second electrical conductors are electrically insulated from each other when the movable cowl is stopped or displaced relative to the fixed structure of the thrust reverser.

2. The nacelle according to claim 1, wherein the electrical energy-consuming member is part of a variable nozzle actuating system of the movable cowl of the thrust reverser.

3. The nacelle according to claim 2, wherein the electrical energy-consuming member is a motor of the variable nozzle actuating system.

4. The nacelle according to claim 1, wherein the first tubular element and the second tubular element are configured to cooperate such that the first and second tubular elements slide relative to each other and are located opposite to each other when the sliding cowl of the nacelle is closed to form an insulating capacitor or an insulating transformer.

5. The nacelle according to claim 1, wherein the first electrical conductor is electrically connected to the first tubular element.

6. The nacelle according to claim 5, wherein the first electrical conductor electrically contacts at least one end of the first tubular element.

7. The nacelle according to claim 1, wherein the second electrical conductor is electrically connected to the second tubular element.

8. The nacelle according to claim 7, wherein the second electrical conductor electrically contacts at least one end of the second tubular element.

9. The nacelle according to claim 1, wherein the power supply device comprises a first capacitive energy transfer device and a second capacitive energy transfer device,
wherein the first capacitive energy transfer device is electrically connected to the electrical energy source via the first electrical conductor and connected to the electrical energy consuming member via the second electrical conductor, and
wherein the second capacitive energy transfer device is electrically connected to the electrical energy consuming member via the first electrical conductor and connected to the electrical energy source via the second electrical conductor.

10. The nacelle according to claim 9, wherein a capacitance of a connection circuit is compensated by an additional electrical induction.

11. The nacelle according to claim 10, wherein an induction of the connection circuit is compensated by an additional electrical capacitance.

12. The nacelle according to claim 1, wherein the power supply device comprises a first inductive energy transfer device and a second inductive energy transfer device,
wherein the first inductive energy transfer device is electrically connected to the electrical energy source via the first electrical conductor and connected to the electrical energy consuming member via the second electrical conductor,
wherein the second inductive energy transfer device is electrically connected to the electrical energy consuming member via the first electrical conductor and connected to the electrical energy source via the second electrical conductor.

13. The nacelle according to claim 1, wherein the first tubular element comprises at least one main inner surface and at least one main outer surface and the second tubular element comprises at least one secondary inner surface and at least one secondary outer surface.

14. The nacelle according to claim 13, wherein the first tubular element comprises an electrical insulation layer on at least one of the main inner surface and the main outer surface.

15. The nacelle according to claim 13, wherein the second tubular element comprises an electrical insulation layer on at least one of the secondary inner surface and the secondary outer surface.
